(19) United States
(12) Patent Application Publication
(10) Pub. No.: US 2016/0070737 A1
(43) Pub. Date: Mar. 10, 2016

(54) APPARATUS AND METHOD FOR OPTIMIZING TIME SERIES DATA STORE USAGE

(71) Applicant: GE INTELLIGENT PLATFORMS, INC., Charlottesville, VA (US)

(72) Inventors: Sunil MATHUR, East Walpole, MA (US); Justin DeSpenza MCHUGH, Lathem, NY (US); Ryan CAHALANE, Grosse Pointe Park, MI (US); Ward BOWMAN, Mendon, MA (US); Kareem Sherif AGGOUR, Niskayuna, NY (US); John C. LEPPIAHO, Green Bay, WI (US)

(73) Assignee: GE Intelligent Platforms, Inc., Charlottesville, VA (US)

(21) Appl. No.: 14/777,859

(22) PCT Filed: Mar. 18, 2013
(86) PCT No.: PCT/US13/32801

§ 371 Date: Sep. 17, 2015

(51) Int. Cl. G06F 17/30

(52) U.S. Cl. CPC G06F 17/30351; G06F 17/30589

(57) ABSTRACT

A first attribute is associated with a first data storage device and a second attribute is associated with a second data storage device. The first data storage device stores first time series data and the second data storage device stores second time series data. In parallel, the first attribute is applied to the first time series data and the second attribute is applied to the second time series data. The application is effective to cause an alteration of one or more of the first time series data or the second time series data. The alteration may be a thinning or reduction of the time series data.

### CROSS REFERENCES TO RELATED APPLICATIONS

International application no. PCT/US2013/032803 filed Mar. 18, 2013 and published as WO2014149027 A1 on Sep. 25, 2014 and entitled “Apparatus and Method for Optimizing Time Series Data Storage Based Upon Prioritization”;

International application no. PCT/US2013/032802 filed Mar. 18, 2013 and published as WO2014149026 A1 on Sep. 25, 2014 and entitled “Apparatus and method for Memory Storage and Analytic Execution of Time Series Data”;

International application no. PCT/US2013/032810 filed Mar. 18, 2013 and published as WO2014149029 A1 on Sep. 25, 2014 and entitled “Apparatus and Method for Executing Parallel Time Series Data Analytics”;

International application no. PCT/US2013/032823 filed Mar. 18, 2013 and published as WO2014149031 A1 on Sep. 25, 2014 and entitled “Apparatus and Method for Time Series Query Packaging”;

International application no. PCT/US2013/032806 filed Mar. 18, 2013 and published as WO2014149028 A1 on Sep. 25, 2014 and entitled “Apparatus and Method for Optimizing Time Data Storage”;

are being filed on the same date as the present application, the contents of which are incorporated herein by reference in their entireties.

### BACKGROUND OF THE INVENTION

1. Field of the Invention

The subject matter disclosed herein relates to data storage and, more specifically, to the efficient storage of time series data.

2. Brief Description of the Related Art

Data is stored on data storage devices in a variety of different formats. Additionally, various types of data storage devices are used to store data and these data storage devices may vary in cost. In one example, data may be stored according to certain formats on high cost devices such as random access memories (RAMs). In other examples, data may be stored on low cost devices such as on hard disks.

One type of data that is stored on data storage devices is time series data. In one aspect, time series data is obtained by some type of sensor or measurement device and the data is then stored as a function of time. For example, a measurement sensor may take a reading of a parameter at predetermined time intervals, and each of the measurements is stored in memory. Since large amounts of data are typically involved with time series measurements, the storage and retrieval of this data may become inefficient.

The problem has arisen in previous systems and embodiments that data ages and as the data ages, this data may be less and less useful. Even though of less value, the data still takes up space and makes system operation less efficient. The retention of this data is also expensive.

Prior attempts to minimize the cost of retaining historical data used complex workflows to determine the amount of available space in various data stores performed at comparatively long intervals. The results of such analysis were used to determine a data movement, retention and decimation strategy that was then applied to the entire data storage environment. Unfortunately, such embodiments caused systems to still operate inefficiently. This has led to user dissatisfaction with these previous embodiments.

### BRIEF DESCRIPTION OF THE INVENTION

Embodiments of the present invention continuously optimize the use of different data storage devices to efficiently store massive volumes of time series data. A large amount of resources may be required to transmit and/or store large volumes of time series data, and when embodiments of the present invention are applied, efficient transmission and storage are achieved. In one aspect, a mechanism for thinning or reducing a dataset before transmitting it from one storage location to another is provided. In another aspect, a mechanism to thin or reduce data within a particular storage location by periodically applying decimation on the time series data is provided and this is achieved without the requirement that the data be moved to another storage location.

The decision to move and/or thin the data is based on a variety of criteria including, but not limited to, the age of the data, retrieval requirements, the required fidelity of the data, current utilization of each storage medium, transmission mechanism constraints (such as network bandwidth limitations), and resources available in other storage locations. Other examples of criteria are possible.

In one example of the application of the present embodiments, data is moved from a process time series historian to a centralized time series data warehouse. This movement requires a consideration of factors such as the desired fidelity of the data in the data warehouse, the communications mechanism and bandwidth, capacity on the receiving end, and frequency at which transmission must be performed. Before the data is moved, it may be thinned according to one or more predetermined attributes.

In many of these embodiments, a first attribute is associated with a first data storage device and a second attribute is associated with a second data storage device. The first data storage device stores first time series data and the second data storage device stores second time series data. In parallel, the first attribute is applied to the first time series data and the second attribute is applied to the second time series data. The application is effective to cause an alteration of one or more of the first time series data or the second time series data.

In some aspects, the alteration (e.g., reduction or thinning) occurs during a movement of the first time series data or the second time series data. In other aspects, the alteration is a reduction or thinning of the first time series data or the second time series data. In some examples, the reduction is optional, and the data may be merely moved to a different storage location.

In some aspects, the first attribute and the second attribute relate to a criterion such as an age of data at the first data storage device or the second data storage device; a current utilization of a storage media; a retrieval requirement, and available resources at other storage locations. In other examples, the alteration comprises a movement of the first time series data or the second time series data, and/or a deletion of other (third) time series data.

In some examples, the applying is performed periodically and automatically. In other examples, the applying is initiated manually.

In others of these embodiments, an apparatus for optimizing data store usage includes an interface and a processor. The interface is configured with an input and output and the input configured to receive a first attribute and a second attribute.

The processor is coupled to the interface and is configured to associate the first attribute with a first data storage device and the second attribute with a second data storage device. The first data storage device stores first time series data and the second data storage device stores second time series data. The processor is configured to, in parallel, apply the first attribute to the first time series data and the second attribute to the second time series data via the output. The application is effective to cause an alteration of one or more of the first time series data or the second time series data.

### BRIEF DESCRIPTION OF THE DRAWINGS

For a more complete understanding of the disclosure, reference should be made to the following detailed description and accompanying drawings wherein:

FIG. 1 comprises a block diagram illustrating an embodiment for optimizing data storage according to various embodiments of the present invention;

FIG. 2 comprises a flowchart illustrating an embodiment for optimizing data storage according to various embodiments of the present invention; and

FIG. 3 comprises a block diagram illustrating an apparatus for optimizing data storage according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Embodiments of the present invention described herein move time series data between data stores based on criteria including, but not limited to the age of the data, the current utilization of the storage media, retrieval requirements, and available resources in other storage locations. The embodiments described herein are capable of thinning the data as it is moved to reduce the amount of data transmitted and stored. This thinning is based on knowledge concerning the required fidelity, storage location constraints, transmission mechanism constraints, and other considerations. These embodiments are sensitive to information on the conditions related to the available data storage locations, which are used to determine the optimal means for storing data at a given location. Embodiments of the present invention may run or be applied continually, moving data proactively upon reassessment of the conditions in the storage environments. These embodiments may also run at predetermined intervals, based on specified criteria or be triggered manually.

In some aspects, another mode of operation allows these embodiments to employ thinning operations to the data stored directly at a location without the need to move it. This mode of operation may operate on subsets of data at the storage location, determining the amount of thinning based on the age of the data or other criteria. This allows space to be reclaimed within the storage locations without the need to shuffle data. It also allows thinning decisions to be made automatically based on the previously mentioned criteria.

Embodiments of the present invention overcome the problems associated with managing time series data across a number of data stores and do so without manual intervention. This is achieved by allowing the automated movement of data with sensitivity to the characteristics and resources available at the destination and the transmission mechanism. Additionally, embodiments are provided for determining which data store a particular collection of time series values is likely located based on the criteria in use in the environment. Further, decimation is provided as an optional mechanism for reducing the amount of data to be stored or transmitted between two stores and providing a known degree of data fidelity reduction. Still further, optimal use of storage resources is provided based on the needs surrounding time series data, taking into account the available resources both at a single storage location and across a collection of potentially dissimilar storage locations.

In one embodiment of the present invention, predictable movement and storage of large volumes of time series data is provided across a number of dissimilar storage locations, which reduces wasted storage and communication resources. In another advantage, sensitivity to use cases is provided, allowing for decimation as a means for reducing the required space and transmission resources for moving data between data stores. This allows more effective usage of resources when a characterization of the data fidelity, storage requirements, and so forth at a given location are known a priori or can be learned dynamically.

In still other embodiments, the usage of data stores is optimized, reducing the resources required during the lifecycle of a large volume of data. This reduces inefficiencies in the environment which can translate to saved storage and network bandwidth costs and reduced manual effort to manage the data. Further, a procedural approach for determining and optimizing data store usage is provided in an embodiment, allowing the convenient introduction of new tiers and types of storage at a low overhead as manual configurations are removed, obviating the need to manage storage strategies directly on a per workflow basis.

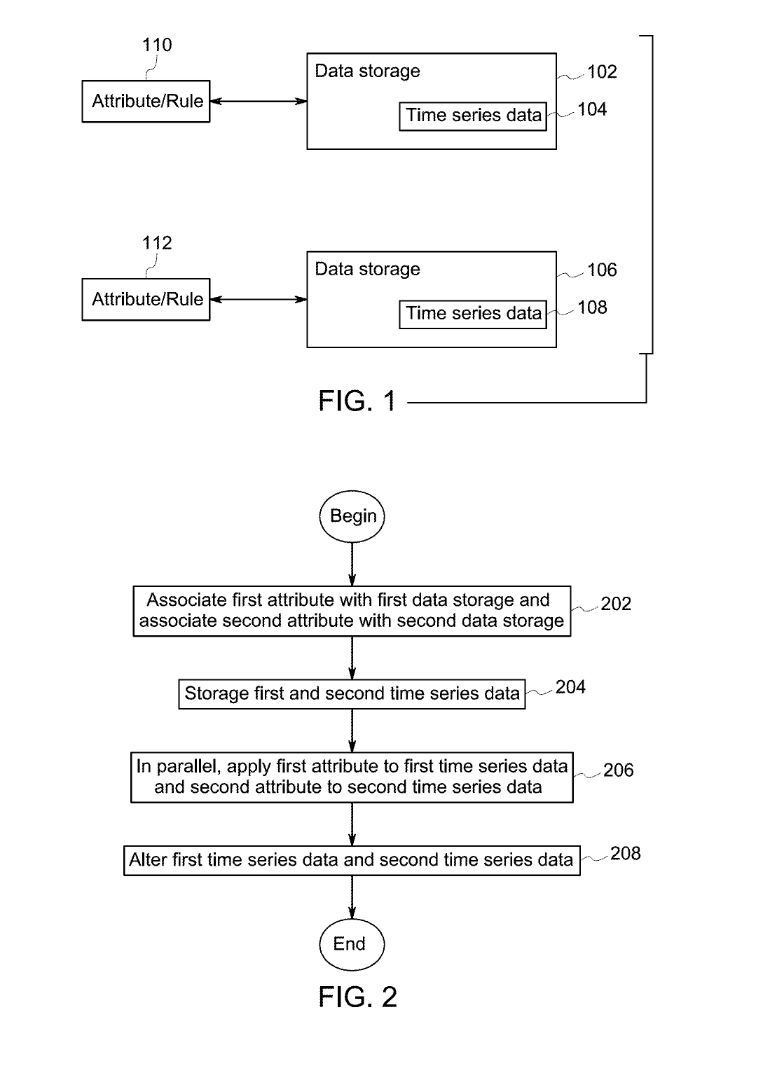

Referring now to FIG. 1, one example of an embodiment for optimizing the storage of time series data is described. As shown in FIG. 1, a first data storage device 102 stores first time series data 104 and a second data storage device 106 stores second time series data 108. A first attribute or rule 110 is associated with the first data storage device and a second attribute or rule 112 is associated with the second data storage device.

The first data storage device 102 and the second data storage devices 106 are any type of data storage device. For example, they can be temporary storage (such as random access memories) or permanent storage (such as hard disk drives). Other examples of storage devices are possible.

The first attribute 110 and the second attribute 112 are criteria that are applied to the data. For example, these attributes may relate to the age of the data, retrieval requirements, the required fidelity of the data, current utilization of each storage medium, transmission mechanism constraints (such as network bandwidth limitations), and resources available in other storage locations. Based upon these characteristics, an attribute or rule is formed. For example, one rule may specify that after data reaches a certain age, then that data is no longer retained. Other examples of rules are possible.

In parallel, the first attribute 110 is applied to the first time series data 104 and the second attribute 112 is applied to the second time series data. The application is effective to cause an alteration of one or more of the first time series data 104 or the second time series data 108. An alteration may be a reduction or movement. The time series data 104 and time series data 108 may be a series of linked records, files, segments, or the like. Alteration may affect some or all of these elements.

In some aspects, the alteration (e.g., reduction) occurs during a movement of the first time series data 104 or the second time series data 108. In other aspects, the alteration is a reduction of the first time series data 104 or the second time series data 108 and the data is not being moved. In some examples, the reduction is optional, and the data may be moved from one location to another.

As mentioned and in some aspects, the first attribute 110 and the second attribute 112 relate to a criterion such as an age of data at the first data storage device or the second data storage device; a current utilization of a storage media; a retrieval requirement, and available resources at other storage locations. In other examples, the alteration comprises a movement of the first time series data or the second time series data, and a deletion of other (third) time series data.

In some examples, the applying is performed periodically and automatically. In other examples, the applying is initiated manually.

Thus, the data stored in the first data storage device 102 and the second data storage device 106 is reduced as it is moved. This thinning is based on knowledge concerning the required fidelity, storage location constraints, transmission mechanism constraints, and other considerations. This embodiment may be applied continually, moving data proactively upon reassessment of the conditions in the storage environments. Additionally, this embodiment may also run at predetermined intervals, based on specified criteria or be triggered manually.

In another mode of operation, thinning operations are applied to the data stored in the first data storage device 102 and the second data storage device 106 without the need to move it. This mode of operation may operate on subsets of data at the storage location (i.e., not all the data stored in the first data storage device 102 or the second data storage device 106), and determine the amount of thinning based on the age of the data or other criteria. This allows space to be reclaimed at the first data storage device 102 and the second data storage device 106 without the need to shuffle data within these devices. It also allows thinning decisions to be made automatically based on the previously mentioned criteria.

Referring now to FIG. 2, one example of an embodiment for optimizing storage of time series data is described. At step 202, a first attribute is associated with a first data storage device and a second attribute is associated with a second data storage device. At step 204, the first data storage device stores first time series data and the second data storage device stores second time series data. At step 206 and in parallel, the first attribute is applied to the first time series data and the second attribute is applied to the second time series data. At step 208, the application is effective to cause an alteration of one or more of the first time series data or the second time series data.

In some aspects, the alteration (e.g., reduction) occurs during a movement of the first time series data or the second time series data. In other aspects, the alteration is a reduction of the first time series data or the second time series data. In some examples, the reduction is optional and the data is merely moved.

In some aspects, the first attribute and the second attribute relate to a criterion such as an age of data at the first data storage device or the second data storage device; a current utilization of a storage media; a retrieval requirement, and available resources at other storage locations. In other examples, the alteration comprises a movement of the first time series data or the second time series data, and a deletion of other (third) time series data. In some examples, the applying is performed periodically and automatically. In other examples, the applying is initiated manually.

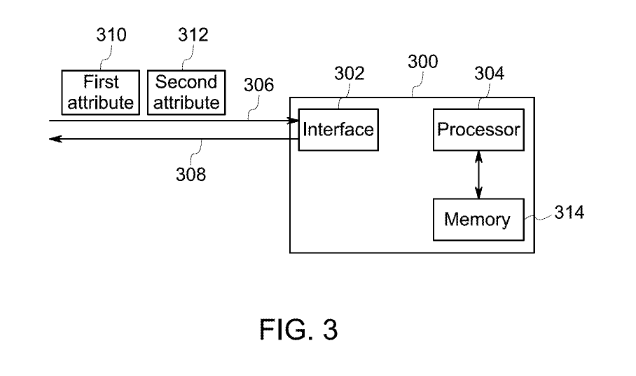

Referring now to FIG. 3, an apparatus 300 for optimizing data store usage includes an interface 302 and a processor 304. The interface 302 is configured with an input 306 and output 308 and the input 306 configured to receive a first attribute 310 and a second attribute 312. The first attribute 310 and the second attribute 312 may be stored in a memory 314.

The processor 304 is coupled to the interface 302 and is configured to associate the first attribute 310 with a first data storage device and the second attribute 312 with a second data storage device.

The first data storage device stores first time series data and the second data storage device stores second time series data. The processor 304 is configured to, in parallel, apply the first attribute 310 to the first time series data and the second attribute 312 to the second time series data via the output. The application is effective to cause an alteration of one or more of the first time series data or the second time series data at the output 308.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method of optimizing data store usage, the method comprising:
associating a first attribute with a first data storage device and a second attribute with a second data storage device, wherein the first data storage device stores first time series data and the second data storage device stores second time series data;
in parallel, applying the first attribute to the first time series data and the second attribute to the second time series data, the applying being effective to cause an alteration of one or more of the first time series data or the second time series data.

2. The method of claim 1 wherein the alteration occurs during a movement of the first time series data or the second time series data.

3. The method of claim 1 wherein the alteration comprises a reduction or thinning of the first time series data or the second time series data.

4. The method of claim 3 wherein the reduction or thinning is optional.

5. The method of claim 1 wherein the first attribute and the second attribute relate to a criterion selected from the group consisting of: an age of data at the first data storage device or the second data storage device; a current utilization of a storage media; a retrieval requirement, and available resources at other storage locations.

6. The method of claim 1 wherein the alteration comprises a movement of the first time series data or the second time series data, and a deletion of third time series data.

7. The method of claim 1 wherein the applying is performed periodically and automatically.

8. The method of claim 1 wherein the applying is initiated manually.

9. An apparatus for optimizing data store usage, the apparatus comprising:
an interface configured with an input and output, the input configured to receive a first attribute and a second attribute;
a processor coupled to the interface, the processor configured to associate the first attribute with a first data storage device and the second attribute with a second data storage device, wherein the first data storage device stores first time series data and the second data storage device stores second time series data, the processor configured to, in parallel, apply the first attribute to the first time series data and the second attribute to the second time series data via the output, the application being effective to cause an alteration of one or more of the first time series data or the second time series data.

10. The apparatus of claim 9 wherein the alteration occurs during a movement of the first time series data or the second time series data.

11. The apparatus of claim 9 wherein the alteration comprises a reduction or thinning of the first time series data or the second time series data.

12. The apparatus of claim 11 wherein the reduction or thinning is optional.

13. The apparatus of claim 9 wherein the first attribute and the second attribute relate to a criterion selected from the group consisting of: an age of data at the first data storage device or the second data storage device; a current utilization of a storage media; a retrieval requirement, and available resources at other storage locations.

14. The apparatus of claim 9 wherein the alteration comprises a movement of the first time series data or the second time series data, and a deletion of third time series data.

15. The apparatus of claim 9 wherein the application is performed periodically and automatically.

16. The method of claim 1 wherein the application is initiated manually.
